(19) United States
(12) Patent Application Publication
(10) Pub. No.: US 2006/0141344 A1
(43) Pub. Date: Jun. 29, 2006

(54) Battery cover latching assembly for portable electronic device

(75) Inventors: Rui-Hao Chen, Shenzhen (CN); Peng-Jin Ge, Shenzhen (CN); Chia-Hua Chen, Tu-Cheng (TW); Hsiao-Hua Tu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/287,072

(22) Filed: Nov. 23, 2005

(30) Foreign Application Priority Data
Dec. 24, 2004 (CN) 200420103470.2

(51) Int. Cl. H01M 2/10

(52) U.S. Cl. 429/97; 429/100

(57) ABSTRACT

A battery cover latching assembly is used in a portable electronic device, which has a battery cover (10) and a housing (40). The battery cover latching assembly (100) includes a latching hole (12) defined in the battery cover, a locking mechanism (300), and a catching portion (42) formed on the housing. The locking mechanism incorporates a button (20). The button has a latching portion (242) disposed on one end thereof. A portion of the button runs through the latching hole of the battery cover and the catching portion of the housing. The latching portion of the button is rotatably engaged with the catching portion of the housing. This arrangement provides a user with both convenient assembly and disassembly operations.

### BACKGROUND OF THE INVENTION

1. Field of the Invention

The present invention generally relates to battery cover latching assemblies and, more particularly, to a battery cover latching assembly for use in a portable electronic device.

2. Discussion of the Related Art

Batteries are widely used in portable electronic devices, such as personal digital assistants (PDAs), mobile phones and so on. Conventional batteries are attachably received in the electronic device, and battery covers are designed to connect with housings of the electronic devices to package the batteries. The batteries have to be replaced by opening the battery covers when the batteries are, e.g., damaged, dead, and/or in need of recharging or replacement.

A clasp structure or latch structure is used with a conventional battery cover to engage with a housing of a portable electronic device. For example, a mobile phone marked Alcatel OT310 has a latch for the battery cover. The latch includes a pair of hooks at one end of the battery cover and a locking pin protruding from the other end of the battery cover. Accordingly, a pair of grooves is defined in an end portion of a backside of a housing of the mobile phone, and a locking hole is defined in the other end portion of the backside of the housing. In assembly, the hooks are firstly inserted into the grooves in the backside of the housing. Then, the battery cover is pressed downwardly to the housing until the locking pin on the battery cover is inserted into the locking hole in the backside of the housing. The battery cover is thus assembled to the housing of the mobile phone. The battery cover is simple in structure, and the engagement between the battery cover and the housing of the mobile phone is firm, too. However, during disassembly, great effort is needed to disassemble the battery cover, thereby requiring a substantial force to be exerted thereon. Therefore, the battery cover is susceptible to damage. As a result, it is inconvenient for a user to replace a battery in the conventional housing of the mobile phone.

Therefore, a new battery cover latching assembly, as well as, of course, a portable electronic device incorporating such a latching assembly, is desired in order to overcome the above-described shortcomings.

### SUMMARY OF THE INVENTION

A battery cover latching assembly for a portable electronic device is provided, which is convenient for a user to operate and which is durable.

In one embodiment thereof, a battery cover latching assembly is used in a portable electronic device, which has a battery cover and a housing. The battery cover latching assembly includes a battery cover, a latching hole defined in the battery cover, a locking mechanism, and a catching portion disposed on the housing. The locking mechanism includes a button. The button has a latching portion disposed on one end thereof The button runs/extends through the latching hole of the battery cover and the catching portion of the housing. The latching portion of the button is rotatably engaged with the catching portion of the housing.

Other advantages and novel features will become more apparent from the following detailed description when taken in conjunction with the accompanying drawing.

### BRIEF DESCRIPTION OF THE DRAWINGS

Many aspects of the battery cover latching assembly can be better understood with reference to the following drawings. The components in the drawings are not necessarily to scale, the emphasis instead being placed upon clearly illustrating the principles of the present battery cover latching assembly. Moreover, in the drawings, like reference numerals designate corresponding parts throughout the several views.

FIG. 1 is an exploded, isometric view of a battery cover latching assembly in accordance with a preferred embodiment;

FIG. 2 is similar to FIG. 1, but viewed from another aspect;

FIG. 3 is an enlarged, isometric view of a button of the battery cover latching assembly shown in FIG. 1;

FIG. 4 is an enlarged, isometric view of a washer of the battery cover latching assembly shown in FIG. 1;

FIG. 5 is an front view of a housing of the battery cover latching assembly shown in FIG. 2;

FIG. 6 is an assembled view of the cover, the button, and the washer of the battery cover latching assembly shown in FIG. 1;

FIG. 7 is an assembled, isometric view of the battery cover latching assembly shown in FIG. 1; and

FIG. 8 is similar to FIG. 7, but viewed from another aspect.

### DETAILED DESCRIPTION OF THE EMBODIMENTS

The present battery cover assembly is suitable for portable electronic devices such as mobile phones, PDAs, and so on.

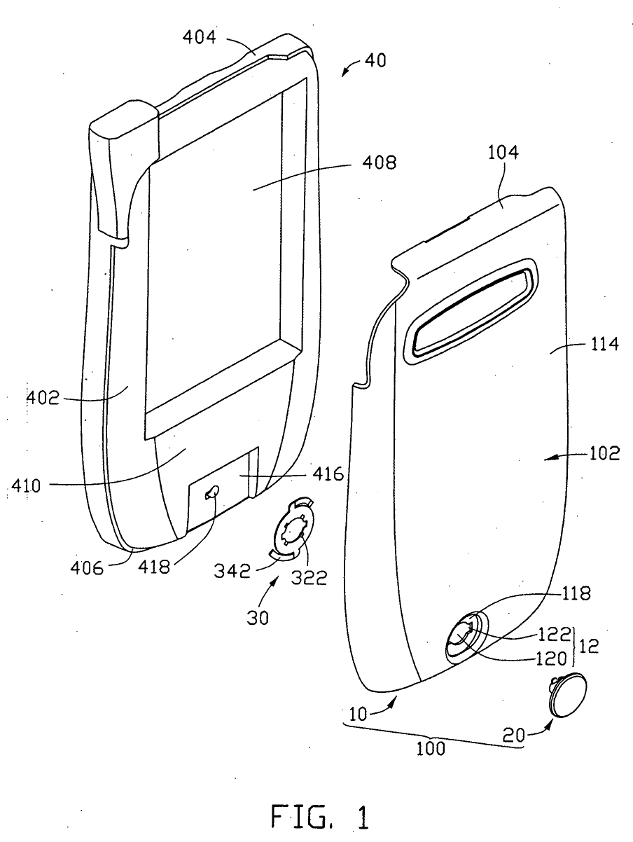

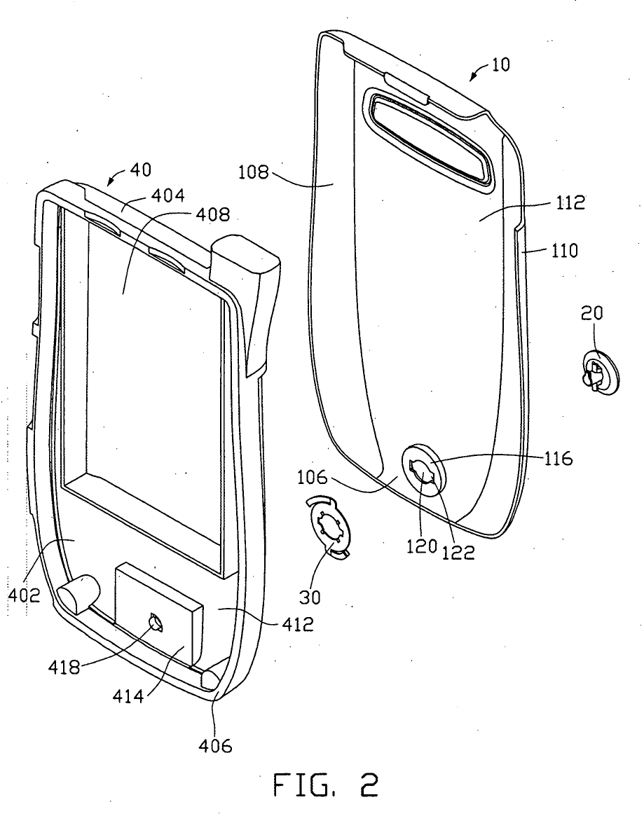

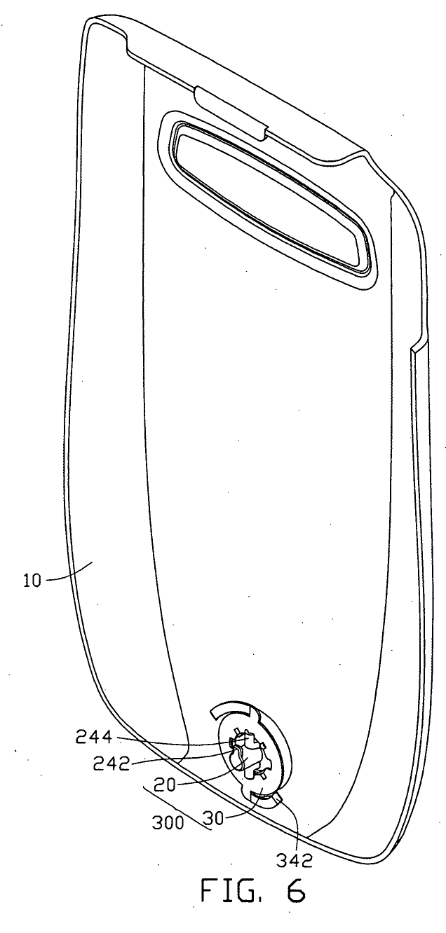

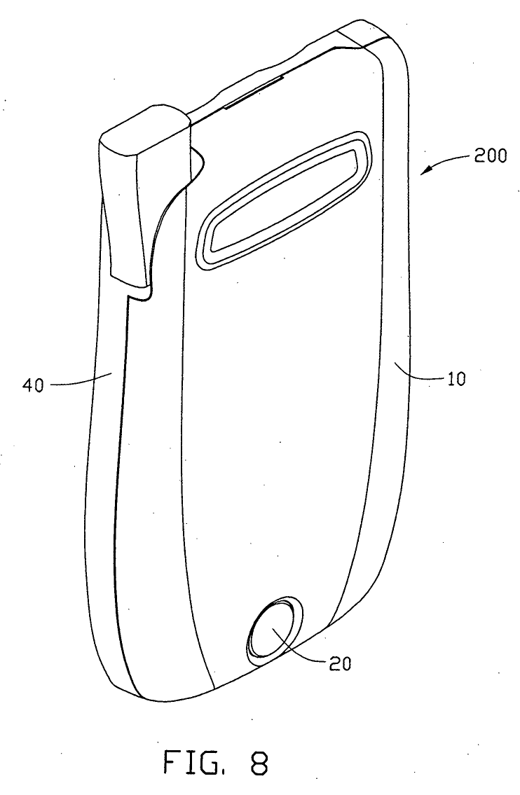

Referring now to the drawings in detail, FIG. 1 and FIG. 2 show a battery cover latching assembly 100 for use in a portable electronic device (e.g., a mobile phone) 200 (as best shown in FIG. 8). The mobile phone 200 is taken here as an exemplary application, for the purposes of describing details of the present battery cover latching assembly 100. The mobile phone 200 includes a battery cover 10 and a housing 40. The battery cover latching assembly 100 includes a latching hole 12 defined in the battery cover 10, a catching portion 42 disposed on the housing 40, and a locking mechanism 300. The locking mechanism 300 (referring to FIG. 6) is locked in the battery cover 10. Accordingly, the battery cover 10 is engaged with the housing 40 of the mobile phone 200 by means of the locking mechanism 300. The locking mechanism 300 includes a button 20 and a washer 30.

The battery cover 10 includes a main body 102, a top wall 104, a bottom wall 106, a left sidewall 108, and a right sidewall 110. The main body 102 includes an inner surface 112, which together with the top wall 104, the bottom wall 106, the left sidewall 108 and the right sidewall 110 defines a substantially rectangular space (not labeled). The main body 102 includes an outer surface 114 opposite to the inner surface 112 thereof. A circular protrusion 116 extends from a middle bottom portion of the inner surface 112 of main body 102, near the bottom wall 106. The circular protrusion 116 is, conversely, recessed from the outer surface 114 of the main body 102 to form a circular groove or indent 118. The circular protrusion 116 has an insertion hole 120 defined in the center thereof and includes two diametrically opposite tab holes/slots 122 relative to the insetting hole 120. The inserting hole 120 is in communication with the tab holes 122. The latching hole 12 includes both the inserting hole 120 and the tab holes 122.

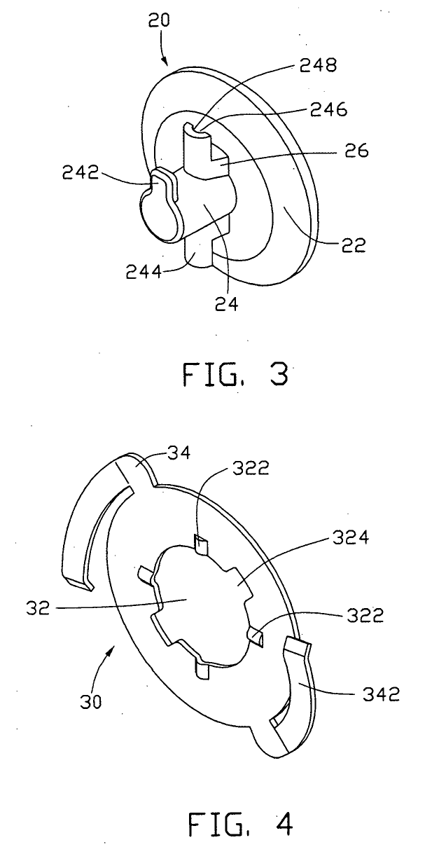

Referring to FIG. 3, the button 20 includes a circular operating portion 22 and a cylindrical post 24 protruding from a center of one side of the operating portion 22. A latching portion 242 extends perpendicularly from a distal end of the post 24, opposite to the operating portion 22. Two opposite, diametrical semicircular latching tabs 244 extend perpendicularly from a middle portion of the outer peripheral wall of the post 24. One latching tab 244 is parallel to the latching portion 242 and located on a same side of the post 24 as the latching portion 242. Each latching tab 244 defines an arcuate groove 246 and an adjacent latch plane 248, facing the operating portion 22. Two stages 26 are respectively disposed between the operating portion 22 and each latching tab 244. Each stage 26 is connected with the post 24.

Referring to FIG. 4, the washer 30 is an circular thin sheet and has a center hole 32 therein. Four arcuate projections 322 are symmetrically formed on the first side of washer 30 around the center hole 32, and two diametrically opposite rectangular openings 324, communicating with the center hole 32, are further defined in the washer 30. Each rectangular opening 324 is disposed between a pair of adjacent arcuate projections 322. The washer 30 has two extending portions 34, each radiating from an outer periphery thereof. Two elastic arms 342 extend from a given distal end of a respective extending portion 34. The two elastic arms 342 are arranged to extend along a same circumferential direction and to protrude from the first side of the washer 30.

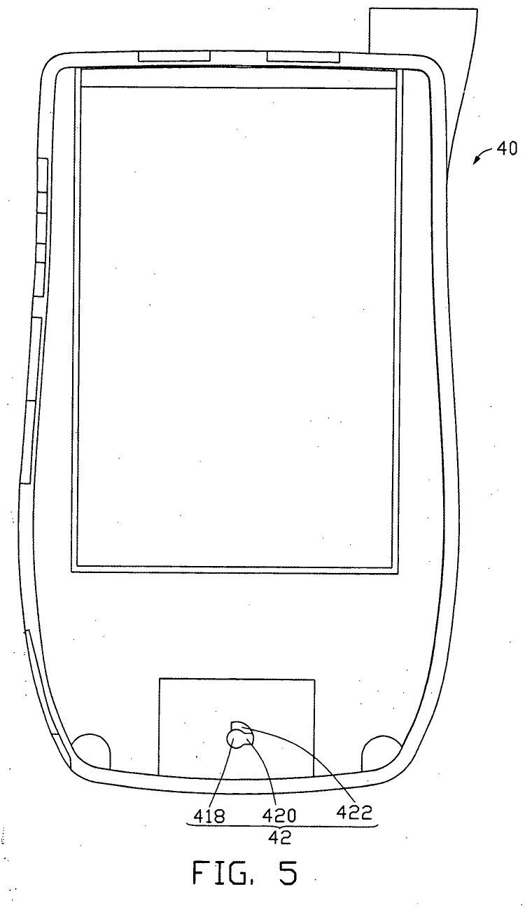

Referring to FIGS. 1, 2 and 5, the housing 40 is a portion of the mobile phone 60 for accommodating an electronic device (not shown), such as a printed circuit board, therein. This accommodation occurs when the housing 40 is assembled with other elements (not shown) of the mobile phone 60. The housing 40 includes a main body 402 with a top end 404 and a bottom end 406. The main body 402 defines a substantially rectangular cavity 408 adjoining/proximate the top end 404. The cavity 408 is used and thereby configured to receive a battery (not illustrated). The main body 402 includes an outer surface 410 facing the battery cover 10 and an inner surface 412. A rectangular protrusion 414 rises from a middle bottom portion of the inner surface 412 of main body 402, near the bottom end 406. The rectangular protrusion 414, conversely, is recessed from the outer surface 410 of the main body 402 to form a rectangular groove or indent 416 in the outer surface 410. A catching hole 418 is defined in the center portion of the rectangular protrusion 414. A tab hole/slot 420, communicating with the catching hole 418, is further defined in the rectangular protrusion 414. An arc guiding slot (not labeled) is defined in the rectangular protrusion 414 adjacent the tab hole 420. An inclined plane 422 is formed on the bottom of the arc guiding slot. The tab hole 420 is configured for engagingly receiving the latching portion 242 of the button 20. The catching hole 418, the tab hole 420 and the inclined plane 422 together defines a catching portion 42 for engaging with the latching portion 242.

In assembly, referring now to FIG. 6, firstly, the washer 30 is pasted on the inner surface 112 of the battery cover 10 by a glue/adhesive or otherwise attached thereto. The washer 30 is attached so that the center hole 32 and the rectangular openings 324 thereof respectively align with the inserting hole 120 and the tab holes 122 of the battery cover 10. Each elastic arm 342 is oriented away from the battery cover 10. Secondly, the button 20 is pressed into and inside of the battery cover 10. The post 24 of the button 20 passes through the inserting hole 120 of the battery cover 10 and the center hole 32 of the washer 30, with the latching tabs 244 of the button 20 passing through the tab holes 122 of the battery cover 10 and the rectangular openings 324 of the washer 30. The button 20 is rotated a predetermined angle so that the latching tabs 244 of the button 20 pivot away from the rectangular openings 324 of the washer 30. The latching tabs 244 of the button 20 thereby resist the first side of the washer 30. Thus, the button 20 is thus rotatably attached to the battery cover 10 (best seen in FIG. 6).

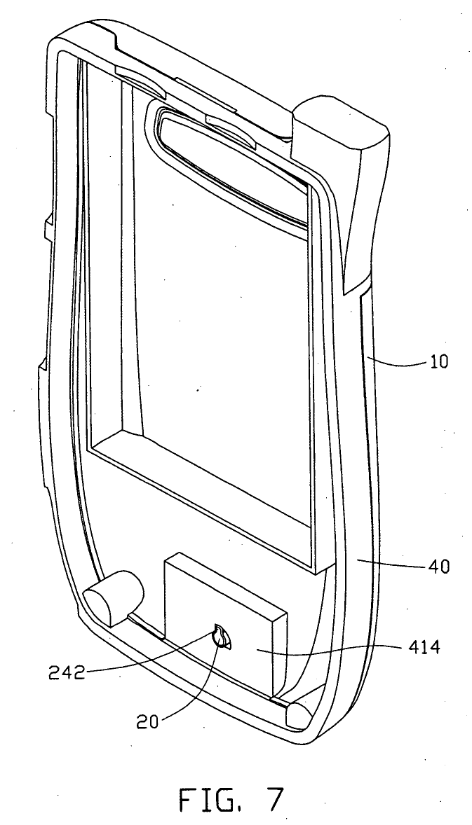

Next, referring also to FIGS. 7 and 8, thirdly, the combined battery cover 10 is attached to the housing 40 as follows. The post 22 of the button 20 runs through the catching hole 418 of the housing 40, with the latching portion 242 of the button 20 passing through the tab hole 420 of the housing 40. Then, the button 20 is rotated about 90 degree counter-clockwise, as shown in FIG. 7. This rotation causes the latching portion 242 to slide along the inclined plane 422 of the guiding slot of the housing 40, thereby effectively latching the battery cover 10 and the housing 40 together. As a further result of such rotation, the distance between the battery cover 10 and the housing 40 is reduced, and the elastic arms 342 of the washer 30 are compressed. The arcuate groove 248 of each latching tab 244 of the button 20 engages with a corresponding arcuate projection 322 of the washer 30. The battery cover 10 is thus removably attached to the housing 40.

When the battery cover 10 is detached from the housing 40, the button 20 is rotated clockwise, as shown in FIG. 7, and the latching portion 242 of the button 20 slides along the inclined plane 422 of the guiding slot of the housing 40 toward the tab hole 420 of the housing 40. When the button 20 is rotated about 90°, the latching portion 242 of the button 20 slides into the tab hole 420. Then, the battery cover 10 is uplifted from the housing 40, under the resilient force of the elastic arms 32 of the washer 30. Finally, the battery cover 10 is pulled away from the housing 40 by means of a user putting his/her finger in the circular groove/indent 416 of the battery cover 10. At the same time, the arcuate groove 248 of each latching tab 244 of the button 20 engages with a corresponding arcuate projection 322 of the washer 30.

In alternative embodiments, one or more latching tabs 244 (not just two thereof) could be provided. This alternate arrangement may be suitable so long as the latching tabs 244 do not outnumber the rectangular openings 324 of the washer 30 and so long as they generally can be aligned with such openings 324 to permit their inertial insertion through the washer 30. As a further alternative, the arcuate groove/projection combination could be eliminated from the design. However, it is advantageous for at least one such combination to exist as the engagement thereof helps deter the accidental rotation and potential disengagement of the button 20 relative to the washer 30.

As described above, the preferred embodiment provides a battery cover latching assembly 100 for devices such as mobile phones 200. When the button 20 is pushed, the cover 10 of the battery cover assembly 100 can be easily removed. This provides the user with convenient operation of the device with respect to accessing the battery.

In alternative embodiment section, it is further realized that the battery cover latching assembly could be applied to the assembly of two parts other than a battery cover and a housing and that the resulting assembly would be considered to be within the scope of use of the present latch assembly.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device including a battery cover, a battery cover latching assembly, and a housing, the battery cover latching assembly comprising:
a latching hole defined in the battery cover;
a locking mechanism comprising a button, the button having a latching portion disposed on one end thereof; and
a catching portion disposed on the housing, the latching portion of the button being insertable through the latching hole of the battery cover and the catching portion of the housing, the latching portion of the button rotatably engaging with the catching portion of the housing.

2. The portable electronic device as claimed in claim 1, wherein the battery cover has a circular protrusion extending from an inner surface thereof and recessed from an outer surface thereof to form a corresponding circular indent within the outer surface of the battery cover, the latching hole including an inserting hole and two diametrically opposite tab holes defined in the circular protrusion, the tab holes of the circular protrusion being in communication with the inserting hole.

3. The portable electronic device as claimed in claim 2, wherein the catching portion includes a catching hole, a tab hole, and a guiding slot each defined in the housing, the tab hole of the catching portion being adjacent to and in communication with the catching hole.

4. The portable electronic device as claimed in claim 3, wherein the button includes an operating portion and a post protruding from a center of one side of the operating portion.

5. The portable electronic device as claimed in claim 4, wherein the latching portion is formed on a distal end of the post.

6. The portable electronic device as claimed in claim 5, wherein two opposite semicircular latching tabs extend perpendicularly from a middle portion of the outer wall of the post, each latching tab defining an arcuate groove, the latching tabs are configured for insertion through the tab holes of the battery cover.

7. The portable electronic device as claimed in claim 4, wherein the operating portion is received in the circular indent.

8. The portable electronic device as claimed in claim 6, wherein the locking mechanism further comprises a washer.

9. The portable electronic device as claimed in claim 8, wherein the washer has two extending portions radiating therefrom, each extending portion of the washer having a respective elastic arm extending from a distal end thereof

10. The portable electronic device as claimed in claim 8, wherein the washer defines a center hole, at least two arcuate projections being symmetrically formed on a first side of washer, each arcuate projection being proximate the center hole, the washer further having two diametrically opposite rectangular openings defined therein, each rectangular opening being in communication with the center hole.

11. The portable electronic device as claimed in claim 9, wherein the washer is secured on the inner surface of the cover, with the center hole and the rectangular openings aligning with the inserting hole and the tab holes of the battery cover.

12. The portable electronic device as claimed in claim 10, wherein the post extends through the inserting hole of the battery cover, the center hole of the washer, and the catching hole of the housing, and the latching portion engaging with the guiding slot.

13. The portable electronic device as claimed in claim 10, wherein the latching portion has a position where at least one arcuate groove of the respective latching tabs of the button engages with a corresponding projection of the washer.

14. An assembled device including a first member, a first member latching assembly, and a second member, the first member latching assembly comprising:
a latching hole defined in the first member;
a locking mechanism comprising a button, the button having a latching portion disposed on one end thereof; and
a catching portion disposed on the second member, the latching portion of the button being insertable through the latching hole of the first member and the catching portion of the second member, the latching portion of the button rotatably engaging with the catching portion of the second member.
